(19) United States
(12) Patent Application Publication
(10) Pub. No.: US 2026/0099432 A1
(43) Pub. Date: Apr. 9, 2026

(54) SYSTEMS AND METHODS FOR PREDICTING SOFTWARE TEST CASE OUTCOMES

(71) Applicant: AgileAI Labs, Inc., Manchester, NH (US)

(72) Inventor: Scott AZIZ, Salem, NH (US)

(21) Appl. No.: 19/344,484

(22) Filed: Sep. 29, 2025

Related U.S. Application Data
(60) Provisional application No. 63/704,836, filed on Oct. 8, 2024.

(51) Int. Cl. G06F 11/3668

(52) U.S. Cl. CPC G06F 11/3688; G06F 11/3692

(57) ABSTRACT

Implementations may extract a feature from the software code, retrieve from a database a test case corresponding to the feature, map the test case to the feature, and predict, by a hybrid prediction model comprising a trained machine learning model and a large language model, whether the feature is likely to pass or fail the test case, thereby yielding a test outcome including the passage likelihood.

### CROSS-REFERENCE TO RELATED APPLICATIONS

This application claims priority to U.S. Provisional Application No. 63/704,836, filed on 8 Oct. 2024, the entire disclosure of which is hereby incorporated by reference.

### BACKGROUND

In modern software development, the continuous integration and deployment (“CI/CD”) paradigm requires frequent testing of code changes to ensure software reliability and quality. Testing is a critical but resource-intensive phase, often involving the execution of numerous test cases to validate new code changes. Traditional approaches execute all relevant test cases after each code commit, which can be time-consuming and computationally expensive.

Conventionally, software code development often involves a cyclical process of writing, compiling, and testing code. Developers write segments of code and then compile them to check for syntactic errors. After compilation, the code is typically executed in a test environment to identify functional errors, logical flaws, and performance issues. This iterative process of development and execution-based testing can be time-consuming and resource-intensive, particularly for large and complex software projects with numerous dependencies and intricate functionalities.

A significant challenge in conventional software development and testing is the overhead associated with executing test cases. Each execution can require setting up a specific test environment, deploying the code, running a suite of tests, and then analyzing the results. In scenarios where multiple changes are introduced or where the codebase is frequently updated, this can lead to a substantial number of unnecessary test executions, consuming valuable computing resources, developer time, and potentially incurring costs associated with cloud infrastructure or specialized testing tools.

As software projects grow in complexity, the number of test cases increases, leading to longer testing times and delayed feedback to developers. Early detection of potential failures can significantly improve productivity by allowing developers to address issues promptly.

Existing solutions focus on prioritizing test cases based on historical failure rates or code coverage metrics. However, these methods still require the execution of test cases to determine their outcomes. There is a need for a system that can predict the outcomes of test cases without executing them, by intelligently analyzing the underlying application code.

Furthermore, conventional testing methodologies primarily rely on execution-based feedback, meaning that issues are only identified after the code has been run. This reactive approach can lead to delays in identifying and resolving critical defects, especially if errors manifest only under specific, less frequently tested conditions or in complex interactions between different software components. Such delays can impact development cycles, increase the risk of introducing bugs into production, and ultimately affect the overall quality and reliability of the software.

### SUMMARY

This Summary is intended to introduce, in an abbreviated form, various topics to be elaborated upon below in the Detailed Description. This Summary is not intended to identify key or essential aspects of the claimed invention. This Summary is similarly not intended for use as an aid in determining the scope of the claims.

In some aspects, the techniques described herein relate to a method for predicting a passage likelihood of a software code as applied to a test case, including, by a processor: receiving the software code at the processor; extracting a feature from the software code; retrieving from a database stored on a memory in electronic communication with the processor a test case corresponding to the feature; mapping the test case to the feature; and predicting, by a hybrid prediction model including a trained machine learning model and a large language model, whether the feature is likely to pass or fail the test case, thereby yielding a test outcome including the passage likelihood.

In some aspects, the techniques described herein relate to a method, wherein the hybrid prediction model includes an ensemble integration layer configured to integrate an output of the trained machine learning model with an output of the large language model.

In some aspects, the techniques described herein relate to a method, further including determining using the hybrid prediction model a confidence score of the passage likelihood.

In some aspects, the techniques described herein relate to a method, further including transmitting, via a network interface in electronic communication with the processor, the test outcome to an external device.

In some aspects, the techniques described herein relate to a method, further including: receiving, via a network interface in electronic communication with the processor, user feedback corresponding to the test outcome; training the hybrid prediction model using the user feedback.

In some aspects, the techniques described herein relate to a method, further including training the hybrid prediction model using the test outcome.

In some aspects, the techniques described herein relate to a method, wherein the extracting the feature from the software code includes determining a segment of the software code that has been changed from a prior version of the software code, thereby yielding the feature.

In some aspects, the techniques described herein relate to a method, further including assigning a test execution priority to the test case based on the passage likelihood.

In some aspects, the techniques described herein relate to a method, further including identifying, by the hybrid prediction model, a developer behavior pattern based on the software code.

In some aspects, the techniques described herein relate to a method, further including suggesting, by the hybrid prediction model, a further test case.

In some aspects, the techniques described herein relate to a method, further including generating, by the large language model, a natural language explanation of the test outcome.

In some aspects, the techniques described herein relate to a system for predicting a passage likelihood of a software code as applied to a test case, including: a processor of an application server; and a memory in electronic communication with the processor, the memory having a database stored thereon; wherein the processor is configured to: receive the software code; extract a feature from the software code; retrieve from the database a test case corresponding to the feature; map the test case to the feature; and predict, by a hybrid prediction model including a trained machine learning model and a large language model, whether the feature is likely to pass or fail the test case, thereby yielding a test outcome including the passage likelihood.

In some aspects, the techniques described herein relate to a system, wherein the hybrid prediction model includes an ensemble integration layer configured to integrate an output of the trained machine learning model with an output of the large language model.

In some aspects, the techniques described herein relate to a system, further including a network interface in electronic communication with the processor, wherein the processor is configured to transmit, via the network interface, the test outcome to an external device.

In some aspects, the techniques described herein relate to a system, wherein the memory includes stored thereon a frequently-accessed feature vector.

In some aspects, the techniques described herein relate to a system, wherein the database includes a time-series database optimized for fast querying of temporal data.

In some aspects, the techniques described herein relate to a system, wherein the database includes a distributed database.

In some aspects, the techniques described herein relate to a system, wherein the extracting the feature from the software code includes determining a segment of the software code that has been changed from a prior version of the software code, thereby yielding the feature.

In some aspects, the techniques described herein relate to a system, wherein the processor is further configured to generate, by the large language model, a natural language explanation of the test outcome.

In some aspects, the techniques described herein relate to a tangible, non-transitory, computer-readable media having instructions thereupon which when implemented by a processor cause the processor to perform a method for predicting a passage likelihood of a software code as applied to a test case, including: receiving the software code at the processor; extracting a feature from the software code; retrieving from a database stored on a memory in electronic communication with the processor a test case corresponding to the feature; mapping the test case to the feature; and predicting, by a hybrid prediction model including a trained machine learning model and a large language model, whether the feature is likely to pass or fail the test case, thereby yielding a test outcome including the passage likelihood.

### BRIEF DESCRIPTION OF THE FIGURES

For a fuller understanding of the nature and objects of the disclosure, reference should be made to the following detailed description taken in conjunction with the accompanying drawings, in which:

FIG. 1 illustrates a workflow for predictive code testing, according to one or more implementations herein.

FIG. 2 illustrates a sequence diagram, according to one or more implementations herein.

FIG. 3 Illustrates an operational environment, according to one or more of the implementations herein.

FIG. 4 is a diagram of example components of a computing device, according to one or more implementations herein.

FIG. 5 is a diagram of example components of a device, according to one or more implementations herein.

FIG. 6 is a diagram of a system, according to one or more implementations herein.

FIG. 7 illustrates a component diagram, according to one or more implementations herein.

FIG. 8 is a flowchart illustrating an example method, according to one or more implementations herein.

FIG. 9 is a flowchart illustrating an example method for predicting a passage likelihood of a software code as applied to a test case, according to one or more implementations herein.

FIG. 10 illustrates a developer interface, according to one or more implementations herein.

FIG. 11 illustrates an example of a developer interface displaying a feedback prompt, according to one or more implementations herein.

FIG. 12 illustrates an artificial neural network (ANN), according to one or more implementations herein.

FIG. 13 illustrates a node, according to one or more implementations herein.

FIG. 14 illustrates a method of training a machine learning model of a machine learning module, according to one or more implementations herein.

FIG. 15 illustrates a method of analyzing input data using a machine learning module, according to one or more implementations herein.

### DETAILED DESCRIPTION

Implementations disclosed herein include systems and methods for predictive code analysis that provide an indication as to whether the code is expected to pass execution testing without executing the code. In this way, implementations solve the problem of unnecessary, extraneous, or risky test environment code executions, which are endemic to software development. Implementations herein may be used for predicting the outcomes of software test cases by leveraging artificial intelligence to analyze the underlying application code associated with each test case. Implementations employ multiple interconnected components working together to provide accurate predictions.

Implementations may provide for this in part by applying mapped test cases to the code using a hybrid prediction model. The hybrid prediction model may utilize a trained machine learning model (e.g., an artificial neural network) and a large language model. These models working in concert as the hybrid prediction model (e.g., integrated via an ensemble integration layer) may yield a test outcome representative of a passage likelihood resulting from diagnosis of problematic code that would be expected to produce an error (e.g., an error, fault, failure, failed dependency, or crash) if the code were to be executed. This test outcome may be provided by the user for review, correction, or feedback. The test outcome, passage likelihood, or the feedback from the user may be utilized by the system to further train or optimize any or all of the trained machine learning model, the large language model, or the ensemble integration layer.

Such implementations may attenuate or obviate issues arising uniquely in the field of computer technology. One such advantage is that unnecessary or extraneous code executions may be eliminated. The need to set up or use test environments, whether local or remote, may be reduced. This may reduce demand for resources, both reducing computing energy demand—increasing computing energy efficiency—and increasing allocation efficiency for computing resources. Further, risks of faults, errors, or crashes may be reduced by diagnosing problematic code without execution.

The demand for network bandwidth and API workflow usage has increased dramatically, in part because of the continued acceleration of interconnectedness of software systems. Where the development workflow or code executions require interfacing with other systems over a network (e.g., via an API or cloud computing), by eliminating unnecessary or extraneous code executions, implementations may reduce the need for network bandwidth and the cost of interfacing with such external systems.

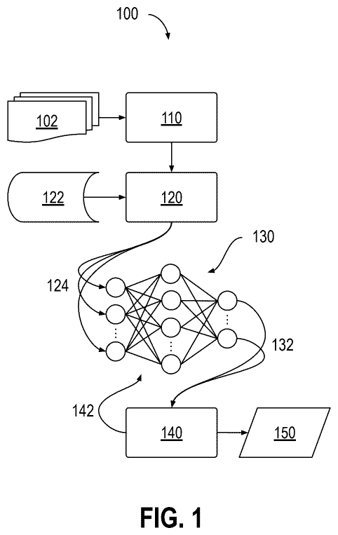

FIG. 1 illustrates a workflow 100 for predictive code testing, according to one or more implementations herein. Implementing the workflow 100 may provide for increased efficiency in software development by reducing unnecessary test code executions by providing a user with a predictive test outcome including a passage likelihood and, in some implementations, a testing priority.

The workflow 100 may be configured to perform operations based on code 102. The code 102 may include a variety of computer codes and sources. The code 102 may include a variety of computer codes and sources, such as source code, object code, or executable code. Source code is human-readable code written in a programming language (e.g., Python, Java, C++). It is typically stored in text files (.py, .java, .cpp) on version control systems (e.g., Git, SVN) and transmitted over networks via file transfer protocols (e.g., SCP, FTP) or through version control system operations (e.g., push, pull). Development of source code involves integrated development environments (IDEs) or text editors, compilers/interpreters, and debuggers. Object code is a machine-readable representation of source code after compilation, often stored as .o or .obj files. Executable code is a directly runnable program, typically stored as .exe (Windows), .dmg (macOS), or ELF (Linux) files, and transmitted via download from servers or through package managers. Development of object and executable code involves linking and building processes after compilation.

The code 102 may be received by a code analysis module 110. The code analysis module 110 may extract features from the application code using advanced parsing techniques and abstract syntax tree generation. The code analysis module may employ natural language processing (“NLP”) techniques (e.g., bidirectional encoder representations from transformers (“BERTs”), generative pre-trained transformers (“GPTs”), or other NLP functionality) to analyze comments, documentation, and natural language elements within the code. The NLP components may identify and extract key concepts from natural language descriptions embedded in the code, use sentiment analysis on code review comments to detect potentially risky code based on developer feedback, and suggest relevant test cases based on documentation or code comments.

The extracted features may then pass to a test case mapping module 120. The test case mapping module 120 may receive one or more test cases from a test case repository 122. The test case mapping module 110 may associate test cases with relevant code segments using sophisticated code coverage analysis and dependency tracking algorithms.

The test case repository 122 may include a variety of software test cases. Software test cases may include structured sets of conditions and steps designed to verify a specific functionality or aspect of a software application. They may serve to validate software quality and ensure that developed code meets its intended requirements. Each test case may include a unique identifier, a descriptive title or objective, preconditions that must be met before execution, the exact steps to be performed, expected results, and postconditions that describe the state of the system after the test. These elements may collectively provide a clear and repeatable procedure for evaluating software behavior.

Test cases can vary in scope and complexity, ranging from unit tests that validate individual functions or methods, to integration tests that verify interactions between different software components, to system tests that assess the complete application against its specified requirements. They may also be categorized by the type of testing they perform, such as functional tests (verifying behavior against specifications), performance tests (assessing speed and responsiveness), security tests (identifying vulnerabilities), or usability tests (evaluating user experience).

Furthermore, test cases may be associated with metadata that provides additional context and facilitates their utilization in automated testing frameworks and predictive analysis systems. This metadata can include creation date, last modified date, author, priority level, associated requirements or user stories, and historical execution data (e.g., pass/fail rates, execution time). In the context of predictive code testing herein, such metadata, including historical outcomes and links to specific code segments, can be used to train the prediction models. This allows systems to learn patterns and predict future test outcomes, optimizing the testing process by intelligently prioritizing or even bypassing unnecessary test executions based on the likelihood of success.

The extracted features together with their mapped test cases may then be passed as inputs 124 to a hybrid prediction module 130. The hybrid prediction module 130 may include a hybrid prediction model. The hybrid prediction module 130 may include a machine learning prediction engine, which may predict test case outcomes based on code features, utilizing a hybrid neural network architecture combining convolutional and recurrent elements.

The hybrid prediction module 130 may further include a large language model (“LLM”) to enhance the system's understanding of code structures and outcome predictions. The LLM may be configured to: identify potential logic errors, even in novel or complex code structures; recognize patterns that may lead to failures, even when traditional code metrics don't provide obvious indications of risk; generate detailed natural language explanations for why certain test cases are likely to fail; and propose new test cases based on code analysis, enabling more comprehensive test coverage. The LLM may be configured for update as newer or more advanced LLMs become available. The system may provide for fine-tuning of the LLM on specific codebases or retrained entirely as needed to ensure currency with software engineering practice and code patterns.

The hybrid prediction model 130 may provide outputs 132 to a prediction generator module 140. The prediction generator module 140 may provide an ensemble integration layer configured to synthesize the outputs 132 of the models of the hybrid prediction module 130. The predictive risk assessment may represent a muti-factor risk assessment, including prediction confidence scores from the machine learning models, historical reliability of predictions based on similar code changes, complexity and criticality of affected code components, and time pressure and project deadlines to adjust risk estimates based on the development timeline.

The system may provide for failure categorization and recommendations. The system may utilize a hierarchical classification model to categorize potential test failures. This model may employ: multi-label classification for handling multiple failure types; a recommendation engine that suggests fixes based on historical solutions to similar problems; and case-based reasoning to adapt historical bug fixes to new issues, increasing the system's adaptability to novel problems.

The prediction generator module 140 may provide code analysis data 150 for review by a user or to an external system.

Further aspects generated by the system may pertain to developer behavior, which may serve to identify trends that may affect code quality. To analyze developer behavior, the system may utilize: time series analysis to track developer productivity and identify bottlenecks; clustering algorithms to group developers by coding style, identifying common traits in high-performing developers; and anomaly detection to flag unusual coding practices that may lead to defects.

The prediction generator module 140 may also provide training data 142 to the hybrid prediction module 130 to further train aspects of the hybrid prediction model. In this way, the system may continually improve through online learning algorithms that incorporate new data from each test cycle, or selected test cycles. The continuous learning may include: online learning to update models incrementally with new test outcomes; A/B testing to evaluate multiple model variations in production, optimizing prediction performance over time; and reinforcement learning to prioritize long-term model accuracy and utility.

Implementations' architecture may support large-scale deployments and maintain high security standards, ensuring they can handle the demands of modern software development environments. Implementations may provide for containerization (e.g., DOCKER®). Each component of the system may be containerized to provide scalability and flexibility. Containers can be deployed on any cloud provider or on-premises infrastructure, making it easy to adapt the system to different environments.

Implementations may provide for orchestration (e.g., via KUBERNETES®). Container orchestration may provide for system components to scale independently, allowing the system to handle large volumes of code analysis and test case predictions without performance degradation.

Implementations may employ distributed processing frameworks (e.g., APACHE SPARK). Such distributed processing frameworks may implement distributed computing to process large codebases and test cases in parallel, substantially reducing prediction latency and improving performance.

Implementations may employ a microservices architecture, breaking the system down into independent microservices such that each component may scale separately and reducing the impact of individual failures on the overall system.

Implementations may employ end-to-end encryption. Data may be encrypted in transit and at rest, which may provide that sensitive code and test data are protected throughout processing.

Implementations may employ role-based access control, enforcing strict access controls based on user roles, thereby preventing unauthorized access to sensitive data and functions.

Implementations may provide for audit logging. Each system interaction and action, including, inter alia, predictions, code changes, and developer feedback may be logged for traceability and accountability.

Implementations may implement secure enclaves (e.g., INTEL® SGX or AWS NITRO ENCLAVES®). Secure enclaves may provide a trusted execution environment within a computing device, isolating sensitive data and operations from the rest of the system. This isolation ensures that even if the operating system or other applications are compromised, the data and code within the enclave remain protected from unauthorized access or modification.

Implementations may exhibit a modular nature, allowing for easy integration of new features and capabilities. Implementations may include a plugin architecture, a feature flag system, and event-driven architecture.

The plugin architecture may support addition of new programming languages, testing frameworks, and analysis techniques through plugins. Developers can add support for emerging languages and technologies without modifying the core system.

The feature flag system may enable a gradual rollout of new capabilities. Developers can deploy new features to specific teams or projects, allowing for controlled testing and feedback collection before wider release.

The event-driven architecture may enable event-driven communication between components, making it easy to integrate new prediction models, analysis tools, or third-party services without disrupting the existing workflow.

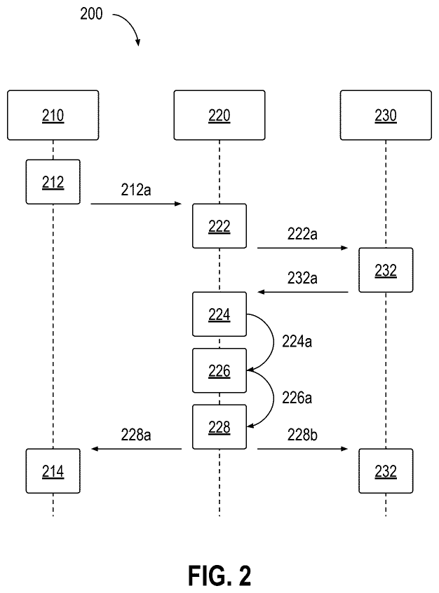

FIG. 2 illustrates a sequence diagram 200, according to one or more implementations herein. The sequence diagram 200 illustrates the interactions between a user device 210, a system 220, and a data repository 230. The user device 210, the system 220 and the data repository may perform one or more of the operations or modules described herein.

The user device 210 may in a request 212a transmit code 212 to the system 220. The system 220 may, with the code 212 received in the request 212a extract one or more features from the code in a code analysis operation 222. Based on the extracted features, the system 220 may retrieve one or more test cases 232 via a request 222a from the data repository 230, which may provide the test cases 232 at response 232a.

The test cases 232 may then be mapped in a test case mapping operation 224 to the extracted features. The mapped test cases and extracted features may then be provided as an input 224a to a hybrid prediction model 226. The hybrid prediction model 226 may process the mapped test cases and the extracted features to provide an output 226a to a prediction generator operation 228.

The prediction generator operation 228a may include providing a response 128a to the user device 210 including feedback 214 in response to the request 212a. The prediction generator operation 228a may further include a storage operation 228b to add the results to the data repository 230. This storage operation 228b may further include training one or more aspects of the hybrid prediction model based on the results.

A component may include, and implementations herein may be implemented using, hardware, firmware, software, or a combination thereof. The actual control hardware or software code used to implement these systems or methods is not limited to the implementations described herein. Thus, the operation and behavior of the systems or methods are described herein without reference to specific software code—it being understood that software and hardware can be used to implement the systems or methods based on the description herein.

A computing device may include one or more of, for example, a server, a desktop computer, a notebook computer, a handheld computer, a tablet computer, a smartphone, a non-smartphone, or other computing platform. A computing device may include, for example, a processor, a memory, a power supply, or a network interface. Unless clearly stated or context necessitates otherwise, a computing device herein may refer to one or more computing devices acting in synchronously or asynchronously to provide the functionality attributed herein to the computing device, for example, according to a parallel architecture, a distributed architecture, a client-server architecture, a cloud architecture, a peer-to-peer architecture, or other architecture, which may include a plurality of hardware, software, or firmware components operating together.

A processor may include or be implemented as one or more of, for example, a central processing unit, an arithmetic logic unit, a graphics processing unit, a microprocessor, a controller, a microcontroller, a digital signal processor, a field-programmable gate array (FPGA), an application-specific integrated circuit (ASIC), or another type of processing component. A processor may be implemented in hardware, firmware, or a combination of hardware and software. A processor may be configured to execute machine-readable instructions for implementing all or some of the implementations herein via circuitry, hardware, storage media, or any other components. A processor may be configured to access, read, retrieve data from, write to, manipulate, or otherwise control a memory. A processor may be configured to execute one or more modules by software, hardware, firmware, other mechanisms for configuring processing capabilities of the processor, or a combination thereof.

A processor may be implemented as a single processor or multiple processors. Unless clearly stated or context necessitates otherwise, a processor herein may refer to one or more processors capable of being programmed to perform a function. Such processors may or may not be all integral to the same physical device and may in some implementations be distributed among several devices.

A module may refer to any component or set of components that perform the functionality attributed to the module. Modules may be implemented using a processor, a memory, or other components of a computing device. Modules or portions thereof may be implemented in any of various ways, including procedure-based techniques, component-based techniques, or object-oriented techniques, among others. For example, the program instructions may be implemented using system libraries, language libraries, model-view-controller (MVC) principles, application programming interfaces (APIs), large language models (LLMs), system-specific programming languages and principles, cross-platform programming languages and principles, pre-compiled programming languages, markup programming languages, stylesheet languages, “bytecode” programming languages, object-oriented programming principles or languages, other programming principles or languages, C, C++, C#, Java, JavaScript, Python, PHP, HTML, CSS, TypeScript, R, Elm, Unity, VB. Net, Visual Basic, Swift, Objective-C, Perl, Ruby, Go, SQL, Haskell, Scala, Arduino, assembly language, Microsoft Foundation Classes (MFC), Streaming SIMD Extension (SSE), or other technologies or methodologies, as desired. Descriptions of the functionality provided by modules herein are for illustrative purposes, and are not intended to be limiting, as any of modules described herein may provide more or less functionality than is described.

A memory may include one or more of, for example, a random-access memory, a read only memory, or another type of memory (e.g., a flash memory, a cache memory, a magnetic memory, or an optical memory). For example, a memory may include optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically readable storage media implemented as, for example, a solid-state disk drive, a hard disk drive, a magnetic disk drive, an optical disk drive, a compact disc, a digital versatile disc, or another type of non-transitory computer-readable medium. A memory may be implemented as a non-transitory (e.g., the medium itself (i.e., tangible, not a signal) as opposed to a limitation on data storage persistency (e.g., RAM vs. ROM)), computer-readable storage medium.

A memory may be integral to (i.e., substantially non-removable) to removably connectable to (e.g., a serial port, a USB port, an IEEE 1394 port, a THUNDERBOLT™ port, disk drive, flash drive, or solid-state drive etc.) a computing device. A memory may alternatively include one or more virtual storage resources (e.g., cloud storage, a virtual private network, or other virtual storage resources). A memory may store, electronically, magnetically, optically, or mechanically, software algorithms, information determined by one or more processors, information received from one or more computing platforms, information received from one or more remote platforms, databases (e.g., structured query language (SQL) databases (e.g., MYSQL®, MARIADB®, MONGODB®, POSTGRESQL®), NO-SQL databases, among others), data files, compiled data, analyzed data, charts, tables, videos, images, presentations, and 3D content in the respective format or other information enabling a computing device or processor thereof to function as described herein.

A memory may be implemented as a single memory or multiple memories. Unless clearly stated or context necessitates otherwise, a memory herein may refer to one or more memories capable of storing data. Such memories may or may not be all integral to the same physical device and may in some implementations be distributed among several devices. As such, a memory may include memory space within a single physical storage device or memory space spread across multiple physical storage devices.

A network may include any variety of devices configured to enable wired or wireless communication between devices or components thereof, for example, via the internet or other networks using, for example, TCP/IP hardware, cellular hardware, or other hardware configured for wired or wireless communication. A network may be implemented, for example, using a receiver, a transmitter, a transceiver, a modem, a network interface card, or an antenna.

Wired communication may include one or more of, for example, a wire, a cable, or a circuit trace implemented as, for example, a bus, a circuit connection, a coaxial connection, a serial connection, a parallel connection, a universal serial bus (USB) connection, a computer network (e.g., CAT-5 or ethernet) connection, an IEEE 1394 connection, a THUNDERBOLT™ connection, or another wired connection.

Wireless communication may include one or more of, for example, cellular, 2G, 3G, 4G, 4G LTE, 5G, 6G, wireless local area network, near field communication (NFC), or BLUETOOTH® communication.

As used herein, “internet” may include an interconnected network of systems and a suite of protocols for the end-to-end transfer of data therebetween. A model describing may be the Transport Control Protocol and Internet Protocol (TCP/IP), which may also be referred to as the internet protocol suite. TCP/IP provides a model of four layers of abstraction: an application layer, a transport layer, an internet layer, and a link layer.

The link layer may include hosts accessible without traversing a router and thus may be determined by the configuration of the network (e.g., a hardware network implementation, a local area network, a virtual private network, or a networking tunnel). The link layer may be used to move packets of data between the internet layer interfaces of different hosts on the same link. The link layer may interface with hardware, for example, via wired communication or wireless communication, for end-to-end transmission of data.

The internet layer may include the exchange of datagrams across network boundaries (e.g., from a source network to a destination network), which may be referred to as routing, and is performed using host addressing and identification over an internet protocol (IP) addressing system (e.g., IPv4, IPv6). A datagram may include a self-contained, independent, basic unit of data, including a header (e.g., including a source address, a destination address, and a type) and a payload (e.g., the data to be transported), to be transferred across a packet-switched network.

The transport layer may utilize the user datagram protocol (UDP) to provide for basic data channels (e.g., via network ports) usable by applications for data exchange by establishing end-to-end, host-to-host connectivity independent of any underlying network or structure of user data.

The application layer may include various user and support protocols used by applications users may use to create and exchange data, utilize services, or provide services over network connections established by the lower layers, including, for example, routing protocols, the hypertext transfer protocol (HTTP), the file transfer protocol (FTP), the simple mail transfer protocol (SMTP), and the dynamic host configuration protocol (DHCP). Such data creation and exchange in the application layer may utilize, for example, a client-server model or a peer-to-peer networking model. Data from the application layer may be encapsulated into UDP datagrams or TCP streams for interfacing with the transport layer, which may then effectuate data transfer via the lower layers.

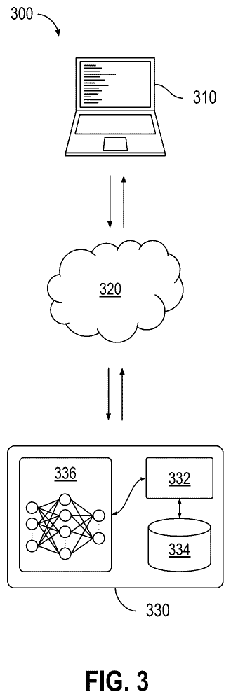

FIG. 3 Illustrates an operational environment 300, according to one or more of the implementations herein. As illustrated in FIG. 3, the operational environment 300 may include a device 310 and a device 330, which may communicate via a network 320. The device 330 may enable predicting a passage likelihood of a software code as applied to a test case.

The device 310 may include a computing device a user may use to interface with the device 330 via the network 320.

The device 330 may include a computing device including, for example, a processor 332, and a memory 334 in electronic communication with the processor and having a database stored thereon. The processor 332 may be configured to interface with a machine learning model 336, which may operate entirely or partially local or remote to the device 330.

The processor 332 may: receive the software code; extract a feature from the software code; retrieve from the database a test case corresponding to the feature; map the test case to the feature; and predict, by the hybrid prediction model 336 comprising a trained machine learning model and a large language model, whether the feature is likely to pass or fail the test case, thereby yielding a test outcome including the passage likelihood. The hybrid prediction model may include an ensemble integration layer configured to integrate an output of the trained machine learning model with an output of the large language model. Extracting the feature from the software code may include determining a segment of the software code that has been changed from a prior version of the software code, thereby yielding the feature. The processor 332 may further, itself or by an LLM, produce a data visualization or natural language explanation of the test outcome.

A network interface in electronic communication with the processor 332 may enable the processor to transmit, via the network interface, the test outcome to the device 310 external to the device 330.

The memory 334 may include stored thereon a frequently-accessed feature vector. The database may include a time-series database optimized for fast querying of temporal data. The database may include a distributed database.

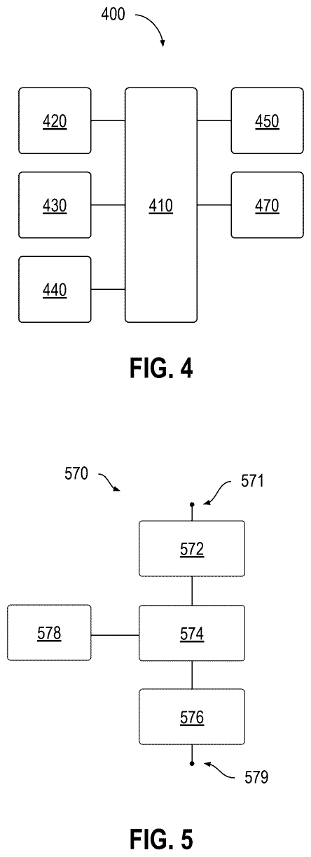

FIG. 4 is a diagram of example components of a computing device 400, according to one or more implementations herein. The computing device 400 may correspond to one or more devices, networks, resources, or services, or a component thereof, of FIG. AAA. The device 400 may include a bus 410, a processor 420, a memory 430, an input component 440, an output component 450, and a communication component 470.

The bus 410 includes a component that enables wired or wireless communication among the components of device 400, allowing for the transfer of data from one component to another.

The processor 420 may be configured to communicate, receive input from, direct output to, or otherwise interact with the memory 430, the input component 440, the output component 450, and the communication component 470.

The memory 430 may be configured to store data or instructions for execution by the processor 420. In some implementations, the memory 430 is integral to the processor 420.

The input component 440 may enable the device 400 to receive input, such as user input or sensed inputs. The input component 440 may represent one or more physical input components. For example, an input component 440 may include one or more of a touch screen, a keyboard, a keypad, a mouse, a button, a microphone, a switch, a sensor (internal or external), a global positioning system component, an accelerometer, a gyroscope, or an actuator.

The output component 450 may enable the device 400 to provide output, such as via a display, a speaker, or one or more light-emitting diodes.

The communication component 470 may enable the device 400 to communicate with other devices, such as via wired communication or wireless communication (e.g., via a network).

The device 400 may perform one or more processes described herein. For example, a non-transitory computer-readable medium (e.g., the memory 430) may store a set of instructions (e.g., one or more instructions, code, software code, or program code) for execution by the processor 420. The processor 420 may execute the set of instructions to perform one or more processes described herein. In some implementations, execution of the set of instructions, by one or more processors delineated by the processor 420, causes a performance of one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

In addition to the example configuration described herein in FIG. 4, various steps, functions, or operations of the device 400 and the methods disclosed herein may be carried out by one or more of, for example, electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link.

FIG. 5 is a diagram of example components of a device 570, according to one or more implementations herein. The device 570 may correspond to the communication component 470 or another device, network interface, or component illustrated or described herein. One or more devices corresponding to the device 570 may operate together to enable or perform the functionality of the device 570 described herein.

The device 570 may include one or more input components 572 (herein referred to collectively as the input components 572 or individually as the input component 572), a switching component 574, one or more output components 576 (herein referred to collectively as the output components 576 or individually as the output component 576), and a controller 578.

The input component 572 may be one or more points of attachment for one or more input physical links 571 (herein referred to collectively as the input physical links 571 or individually as the input physical link 571) and include one or more points of entry for incoming traffic, such as packets. The input component 572 may process incoming traffic, such as by performing data link layer encapsulation or decapsulation. In some implementations, the input component 572 may transmit or receive packets. In some implementations, the input component 572 may include an input line card that includes one or more packet processing components (e.g., in the form of integrated circuits), such as one or more interface cards (IFCs), packet forwarding components, line card controller components, input ports, processors, memories, or input queues. In some implementations, the device 570 may include one or more of the input components 572.

The switching component 574 may interconnect the input components 572 with the output components 576. In some implementations, the switching component 574 may be implemented via one or more crossbars, via busses, or with shared memories. The shared memories may act as temporary buffers to store packets from the input components 572 before the packets are eventually scheduled for delivery to the output components 576. In some implementations, the switching component 574 may enable the input components 572, the output components 576, or the controller 578 to communicate with one another.

The output component 576 may store packets and may schedule packets for transmission on the output physical link(s) 579 (herein referred to collectively as the output physical links 579 or individually as the output physical link 579). The output component 576 may support data link layer encapsulation or decapsulation, or a variety of higher-level protocols. In some implementations, the output component 576 may transmit packets or receive packets. In some implementations, the output component 576 may include an output line card that includes one or more packet processing components (e.g., in the form of integrated circuits), such as one or more IFCs, packet forwarding components, line card controller components, output ports, processors, memories, or output queues. In some implementations, the device 570 may include one or more output components 576. In some implementations, the input component 572 and the output component 576 may be implemented by the same set of components (e.g., an input/output component may be a combination of the input component 572 and the output component 576).

The controller 578 includes a processor that can be programmed to perform a function. In some implementations, the controller 578 may include a RAM, a ROM, or another type of memory that stores information or instructions for use by the controller 578.

In some implementations, the controller 578 may communicate with other devices, networks, or systems connected to the device 570 to exchange information regarding network topology. The controller 578 may create routing tables based on the network topology information, may create forwarding tables based on the routing tables, and may forward the forwarding tables to the input components 572 or the output components 576. The input components 572 or the output components 576 may use the forwarding tables to perform route lookups for incoming or outgoing packets.

The controller 578 may perform one or more processes described herein. The controller 578 may perform these processes in response to executing software instructions stored by a memory.

Software instructions may be read into the memory associated with the controller 578 from another memory or from another device via a communication interface. When executed, software instructions stored in a memory associated with the controller 578 may cause the controller 578 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, the device 570 may include additional components, fewer components, different components, or differently arranged components than those shown in FIG. 5. Additionally, or alternatively, a set of components (e.g., one or more components) of the device 570 may perform one or more functions described as being performed by another set of components of the device 570.

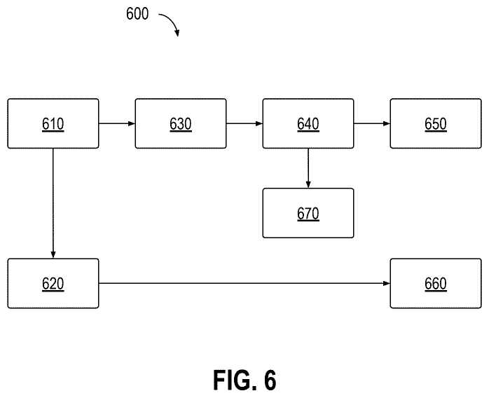

FIG. 6 is a diagram of a system 600, according to one or more implementations herein. The system 600 may comprise several interconnected modules working together to provide accurate test case outcome predictions. The arrows may illustrate the flow of information between these components, demonstrating how code changes propagate through the system to generate predictions and ultimately inform a Cl/CD pipeline 660 and a developer interface 670.

A code analysis module 610, similar to the code analysis module 110, may extract features from the application code using advanced parsing techniques and abstract syntax tree generation.

A test case mapping module 630, similar to the test case mapping module 120, may associate test cases with relevant code segments using sophisticated code coverage analysis and dependency tracking algorithms.

A machine learning prediction engine 640, similar to the hybrid prediction module 130, may predict test case outcomes based on code features, utilizing a hybrid neural network architecture combining convolutional and recurrent elements.

A data repository 650 may store historical code changes, test case definitions, and test results, optimized for fast retrieval and efficient storage.

The results from the machine learning prediction engine 640 may be provided both to the data repository 650 and the developer interface 670. The developer interface 670 may enable viewing predictions and interacting with the system, featuring real-time updates and interactive visualizations.

The code analysis module 610 may further integrate with a version control system 620. The version control system 620 may further integrate with the CI/CD pipeline 660. These integrations may be effected by using application program interfaces (“APIs”) and webhooks to integrate with modern software development workflows.

In some implementations, the version control system 620 or the CI/CD pipeline 660 may compose issue tracking and code review platforms (e.g., JIRA® or GITHUB®). Such integrations may be provided via custom plugins and APIs (e.g., RESTful APIs). Such integrations may enable the system to provide, for example, real-time feedback on code changes during the review process, automatic linking of test case predictions to pull requests and code issues, or sentiment analysis of code review comments to flag areas of potential concern.

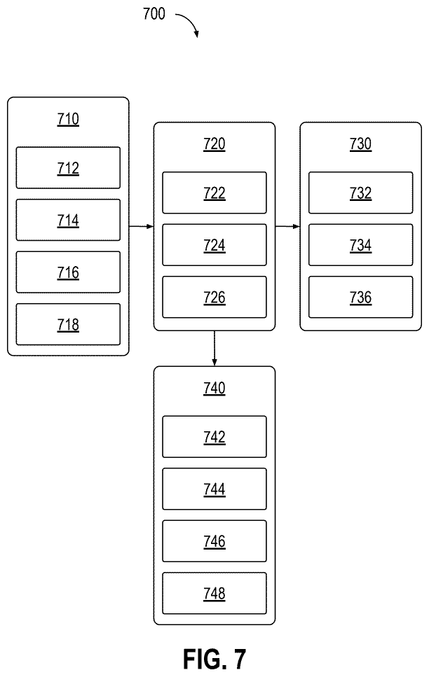

FIG. 7 illustrates a component diagram 700, according to one or more implementations herein. The component diagram 700 may provide further context and detail as to the capabilities of the various modules and components described herein.

A code analysis module 710 may process an application codebase to extract meaningful features that can influence test case outcomes. The code analysis module 710 may include a syntax parser 712, an abstract syntax tree (“AST”) generator 714, a complexity analyzer 716, and a dependency extractor 718.

The syntax parser 712 may perform grammar-based parsing on the code. This parsing may, for example, be parsed using a language recognition tool (e.g., ANother Tool for Language Recognition (“ANTLR”)). The syntax parser 712 may support multiple programming languages via modular grammar definitions. The output of the syntax parser 712 may include a concrete syntax tree (“CST”) as an initial representation of the code. The CST may be used as input to the AST generator 714.

The AST generator 714 may transform the CST into an AST. The AST generator 714 may implement visor patterns to traverse and manipulate the AST. The AST generator 714 may further perform semantic analysis to enrich the AST with type information and symbol resolution.

The complexity analyzer 716 may be used to determine a complexity of the code, the CST, or the AST. This may be performed in some implementations by calculating a cyclomatic complexity using graph theory algorithms on the control flow graph. Further, the complexity analyzer 716 may compute a Halstead complexity measure (e.g., program length, vocabulary, volume, or difficulty). In this way, the complexity analyzer 716 may determine a cognitive complexity based on code nesting and structural patterns.

The dependency extractor 718 may be configured to perform various functions related to mapping and understanding dependencies of code. The dependency extractor 718 may be configured to construct a module dependency graph (MDG) using static analysis techniques, perform data flow analysis to track inter-procedural dependencies, and identify and quantify coupling between different code components.

The syntax parser 712, the AST generator, the complexity analyzer 716, and the dependency extractor 718 may operate in concert to generate a comprehensive feature set for each code segment. This feature set may include, for example, AST-based features, control flow graph characteristics, data flow pattern, code complexity metrics, inter-module dependencies, and natural language features (e.g., extracted from comments and identifiers using natural language processing (“NLP”) techniques). In this way, the code analysis module 710 uses static code analysis techniques to parse and process the code without executing it. Some implementations may utilize plugin architecture to handle a variety of programming languages and frameworks.

The test case mapping module 720 may include a coverage analyzer 722, a dependency tracker 724, and a change impact analyzer 726. Using these components, the test case mapping module 720 may identify which portions of the codebase or extracted features are relevant to each test case.

The coverage analyzer 722 may be configured to implement dynamic instrumentation techniques to track code execution during test runs. The coverage analyzer 722 may utilize code coverage tools (e.g., JaCoCo for Java, Istanbul for JavaScript) to generate detailed coverage reports. Further, the coverage analyzer 722 may aggregate coverage data across multiple test runs to build a comprehensive coverage map.

The dependency tracker 724 may construct a test-code dependency graph (“TCDG”) based on static analysis and historical execution data. The dependency tracker 724 may employ graph traversal algorithms to identify all code segments potentially affected by each test case. The dependency tracker 724 may update dependency information incrementally as code changes are introduced.

The change impact analyzer 726 may compare ASTs of consecutive code versions to identify structural changes. The change impact analyzer 726 may use diff algorithms, which compare differences in code or algorithms, which may be optimized for tree structures, to efficiently detect code modifications. The change impact analyzer 726 may propagate change impacts through the TCDG to determine affected test cases.

In this way, the mapping may be based on code coverage data from previous test executions, static and dynamic dependency analysis, historical test execution patterns, or metadata annotations linking test cases to code modules or functions.

In some implementations, the test case mapping module 710 may implement machine learning techniques, such as decision trees or random forests, to predict test-code relationships for new or modified code segments based on historical patterns.

A machine learning prediction engine module 730 may implement advanced machine learning models trained on historical data. Components of the machine learning prediction engine module 730 may include a feature processor 732, a hybrid prediction model 734, and a prediction generator 736.

The feature processor 732 may perform functions including tokenization, embedding, sequence padding, and feature scaling. A tokenization function may include converting code to a sequence of tokens using a language-specific program that performs lexical analysis (a “lexer”). An embedding function may utilize a word embedding algorithm (e.g., Word2Vec or FastText) to generate one or more dense vector representations of code tokens. A sequence padding function may employ dynamic padding strategies to handle variable-length inputs. A feature scaling function may apply techniques such as min-max scaling or standardization to normalize the feature values.

The hybrid prediction model 734 may implement a hybrid approach combining machine learning techniques with large language model techniques.

A machine learning component may include, for example, a convolutional neural network (“CNN”) or long short term memory (“LTSM”) networks as described herein. The machine learning component may be configured to process structured code features and historical patterns.

A large language model component may implement a transformer-based model (e.g., GPT-4 or another transformer-based model). The large language model employed may be fine-tuned on a diverse corpus of code, documentation, and software engineering literature. The large language model may be capable of, in some implementations, zero-shot and few-shot learning for code analysis and test outcome prediction. The large language model may be trained using, for example, unsupervised pre-training on a large corpus of code from various languages and domains, as well as on specified software testing tasks (e.g., test case generation and outcome prediction). Prompt engineering techniques (e.g., context provisioning, system instructions, model-specific prompt structuring, temperature selection, recursive prompt generation, etc.) may be employed to optimize the large language model's performance on code analysis tasks. The large language model may provide for reasoning about code structure, development of potential edge cases, likely failure modes without relying on historical data, generating natural language explanations for predictions made, enhancing interpretability of code or predictions, or adapting to new programming languages or frameworks with minimal additional training.

Outputs of the machine learning component and the large language model components may be combined in an ensemble integration layer. This may be performed using, for example, a weighted ensemble approach, dynamically adjusting weights based on confidence scores and historical accuracy.

The prediction generator 736 may synthesize the outputs from both the traditional machine learning models and the Large Language Model (LLM) to produce final test case outcome predictions. The prediction generator 736 may apply a sigmoid activation function to obtain probabilities for the pass/fail prediction. A predefined threshold (e.g., 0.5) may be used to classify a test case as likely to pass or fail, yielding a passage likelihood. A confidence score may be calculated based on the distance from the threshold, providing a measure of certainty in the prediction. The prediction generator 736 may implement ensemble methods (e.g., bagging, boosting) to combine multiple model predictions for improved accuracy and robustness. Insights and confidence scores from the LLM may be incorporated into the final prediction, offering a holistic prediction based on both machine learning and AI reasoning.

The system may employ transfer learning to pre-train the model on large, open-source codebases before fine-tuning it on specific project data, ensuring the model is adaptable across different programming environments.

Further, calibration techniques such as Platt scaling or isotonic regression may be employed to ensure that the predicted probabilities are well-calibrated, accurately reflecting the true likelihood of test case outcomes.

This multi-faceted approach enables the prediction generator 736 to produce highly accurate and interpretable test case outcome predictions, leveraging the strengths of both machine learning and large language models.

The data repository 740 may store and manage the vast amounts of data required for, inter alia, accurate prediction of test case outcomes. Components of the data repository 740 may include a code version storage 742, a test case database 744, a historical results archive 746, and a feature cache 748. In some implementations, the data repository may operate using a microservices architecture, which may provide for scalability and fault tolerance. Distributed database systems may be employed to maintain consistency across different data sources. In this way, latency may be reduced, and data synchronization may be accurate and efficient.

The code version storage 742 may utilize a distributed version control system (e.g., Git) to maintain historical versions of the codebase. It may employ delta compression techniques to minimize storage overhead while allowing efficient retrieval of specific versions for analysis.

The test case database 744 may store test case definitions in a hierarchical structure, providing easy access to test case metadata, historical execution data, and related outcomes.

The historical results archive 746 may provide a time-series database optimized for fast querying of temporal data, making it possible to quickly retrieve results from previous test executions.

The feature cache 748 may maintain a cache of frequently accessed feature vectors in-memory to speed up predictions for commonly modified code segments.

The following figures illustrate example methods and operations thereof. In some implementations, a method illustrated herein may include additional operations, fewer operations, differently arranged operations, or different operations than the operations depicted in the following figures. Moreover, or in the alternative, two or more of the operations depicted in the following figures may be performed at least partially in parallel.

In implementations of the methods illustrated in the following figures, various operations may be performed by one or more hardware processors configured by machine-readable instructions (e.g., instructions stored electronically on an electronic storage medium), which may include a module in accordance with one or more embodiments. Such a hardware processor may include one or more processing devices (e.g., one or more digital processors, analog processors, digital circuits designed to process information, analog circuits designed to process information, state machines, and/or other mechanisms for electronically processing information). The one or more processing devices may include one or more devices configured through hardware, firmware, and/or software, which may be specifically designed for execution of one or more of the operations of methods illustrated herein.

In some implementations, one or more operations illustrated the flowcharts herein may be performed by one or more of the devices or components depicted in FIG. 1 through FIG. 6 and FIG. 10 through FIG. 12, in concert, in the alternative, or in combinations thereof. In some implementations, one or more operations may be performed by another device, system, or group of devices or systems separate from or including these. Additionally, or alternatively other devices, components, or systems, may be employed to perform the operations.

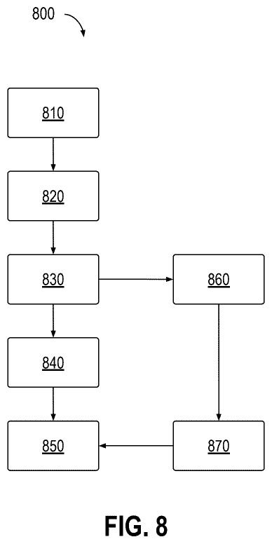

FIG. 8 is a flowchart illustrating an example method 800, according to one or more implementations herein. The method 800 may illustrate a flow of information through a system as described herein, demonstrating how code changes may trigger the analysis process and how feedback from test execution may be used to refine the model.

An operation 810 may include receiving a code commit and may be performed alone or in combination with one or more other operations depicted in FIG. 8. The operation 810 may involve a developer committing new or modified code to a version control system.

An operation 820 may include performing a code analysis and may be performed alone or in combination with one or more other operations depicted in FIG. 8. The operation 820 may involve a code analysis module, which may extract features from the updated code base. The extraction may focus on areas that have been modified (determined, for example, using a diff function).

An operation 830 may include performing a test case mapping and may be performed alone or in combination with one or more other operations depicted in FIG. 8. The test case mapping module may determine which test cases are affected by the code changes.

An operation 840 may include generating a prediction and may be performed alone or in combination with one or more other operations depicted in FIG. 8. The prediction may be generated by a machine learning prediction engine that may predict a passage likelihood for one or more of the test cases. The predictions may be accompanied by confidence scores.

An operation 850 may include generating a developer notification and may be performed alone or in combination with one or more other operations depicted in FIG. 8. The developer notification may provide for the display of predictions to the developer via a developer interface. The developer notification may include a prioritization or flagging of test cases for execution based on failure likelihood.

An operation 860 may include generating a testing prioritization and may be performed alone or in combination with one or more other operations depicted in FIG. 8. The predictions may be used to guide a CI/CD system or developer in determining which test cases should be run and in what order.

An operation 870 may include executing a feedback loop and may be performed alone or in combination with one or more other operations depicted in FIG. 8. The actual test outcomes may be fed back into the system, allowing the model to learn and improve over time.

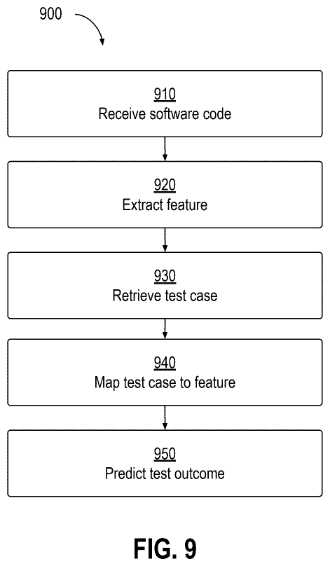

FIG. 9 is a flowchart illustrating an example method 900 for predicting a passage likelihood of a software code as applied to a test case, according to one or more implementations herein.

An operation 910 may include receiving the software code at the processor and may be performed alone or in combination with one or more other operations depicted in FIG. 9.

An operation 920 may include extracting a feature from the software code and may be performed alone or in combination with one or more other operations depicted in FIG. 9. Extracting the feature from the software code may include determining a segment of the software code that has been changed from a prior version of the software code, thereby yielding the feature.

An operation 930 may include retrieving from a database stored on a memory in electronic communication with the processor a test case corresponding to the feature and may be performed alone or in combination with one or more other operations depicted in FIG. 9. The memory may include stored thereon a frequently-accessed feature vector. The database may include a time-series database optimized for fast querying of temporal data. The database may include a distributed database.

An operation 940 may include mapping the test case to the feature and may be performed alone or in combination with one or more other operations depicted in FIG. 9.

An operation 950 may include predicting, by a hybrid prediction model comprising a trained machine learning model and a large language model, whether the feature is likely to pass or fail the test case, thereby yielding a test outcome including the passage likelihood and may be performed alone or in combination with one or more other operations depicted in FIG. 9. The hybrid prediction model may include an ensemble integration layer configured to integrate an output of the trained machine learning model with an output of the large language model.

The method 900 may in some implementations include a further operation of determining using the hybrid prediction model a confidence score of the passage likelihood.

The method 900 may in some implementations include a further operation of transmitting, via a network interface in electronic communication with the processor, the test outcome to an external device.

The method 900 may in some implementations include further operations of receiving, via a network interface in electronic communication with the processor, user feedback corresponding to the test outcome and training the hybrid prediction model using the user feedback.

The method 900 may in some implementations include a further operation of training the hybrid prediction model using the test outcome.

The method 900 may in some implementations include a further operation of assigning a test execution priority to the test case based on the passage likelihood.

The method 900 may in some implementations include a further operation of identifying, by the hybrid prediction model, a developer behavior pattern based on the software code.

The method 900 may in some implementations include a further operation of suggesting, by the hybrid prediction model, a further test case.

The method 900 may in some implementations include a further operation of generating, by the large language model, a data visualization or natural language explanation of the test outcome.

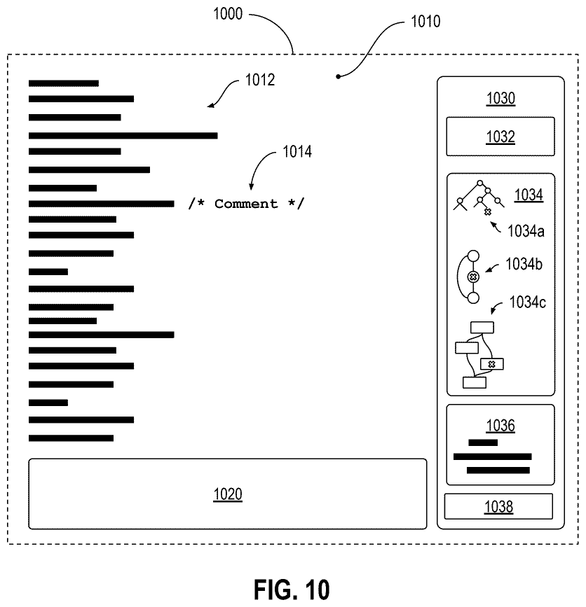

FIG. 10 illustrates a developer interface 1000, according to one or more implementations herein. The developer interface may be used by a developer user to interface with implementations of systems and methods described herein for predictive code analysis. While the developer interface 1000 illustrated in FIG. 10 illustrates the code alongside the predictive code analysis interface elements, it will be understood that such elements are not constrained to such a simultaneous display in every implementation.

The developer interface 1000 may include a code area 1010, which may display the code 1012 subject to analysis according to the methods described herein. The code 1012 may be accompanied by one or more comments 1014, which may be generated by the user, thus providing additional context for the methods described herein, or may be generated by the methods described herein and appended to the code to provide additional feedback to the developer.

The developer interface 1000 may include a terminal area 1020. The terminal area 1020 may provide for entry of command-line instructions or display of command-line feedback. The terminal may provide in various implementations one or more commands, flags, prompts, and options for interacting with the predictive code analysis methods and systems herein.

The developer interface 1000 may include a dashboard 1030. While the dashboard 1030 is illustrated in FIG. 10 as a sidebar, it will be understood that the dashboard 1030 is not so limited by this specification and may thus be visually arranged in a variety of manners.

The dashboard 1030 may include a variety of components for displaying feedback from the predictive code analysis systems and methods described herein. In some implementations, the dashboard 1030 may include a metrics area 1032, a code visualization area 1034, a prediction explainer area 1036, and a feedback area 1038. The dashboard 1030 may be implemented using front-end frameworks (e.g., React or Angular). The dashboard 1030 may implement WebSocket connections to provide real-time updates.

In some implementations, the developer interface 1000 may be configured to initiate code analysis upon receipt of a run instruction from a user, at temporal intervals, on changes, on saves, on commits, on certain code creation events (e.g., function or object closure).

The metrics area 1032 may display predictions, confidence scores, and other relevant metrics once generated, and in some implementations, in real-time.

The code visualization area 1034 may offer interactive visualizations of the AST 1034a, control flow graphs 1034b, and dependency graphs 1034c, allowing developers to visualize connections between code and test cases. The various visualizations may indicate where a code failure is expected to occur (illustrated by the “x” in each code visualization).

The prediction explainer area 1036 may provide one or more explanations of the prediction offered and to assist the user in understanding the model's reasoning. For example, the prediction explainer area 1036 may provide a textual explanation (e.g., generated using a large language model). As a further example, the prediction explainer area 1036 may provide Shapley additive explanations (“SHAP”) values and visualizations to explain why a particular test case is likely to pass or fail.

The feedback area 1038 may provide an interface component by which a user may provide feedback on any aspect of the generated prediction, the passage likelihood, the other metrics, the code visualizations, or the prediction explanation. The feedback area 1038 may implement a variety of user interface mechanisms, including, for example, an “Accept” button, a “thumbs-up” button, a “thumbs-down” button, a “Provide Feedback” button, or the like. In this way, users may submit feedback on the accuracy of the predictions. This feedback may be collected and used to update the machine learning models through an active learning framework.

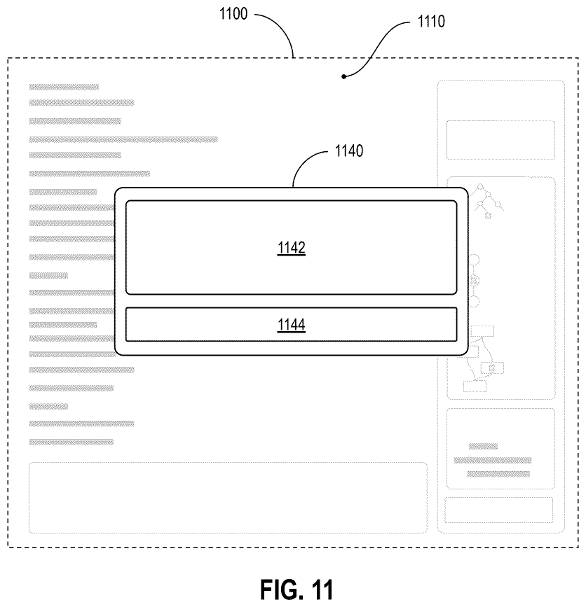

FIG. 11 illustrates an example of a developer interface 1100 displaying a feedback prompt 1140, according to one or more implementations herein. In the example provided, the feedback prompt 1140 may overlay the underlying developer user interface components 1110. The feedback prompt may include an input area 1142 for receiving information in the form of text, radio buttons, dropdowns, sliders, etc., and a submission button 1144.

Implementations may implement machine learning, a type of artificial intelligence (AI) that provides computers with an ability to learn how to process data without being explicitly programmed. Machine learning focuses on the development of computer programs that can teach themselves to grow and change when exposed to new data. Machine learning explores the study and construction of algorithms that can learn from and make predictions based on data. Such algorithms may overcome following strictly static program instructions by making data-driven predictions or decisions, through building a model from sample inputs.

Machine learning may refer to a variety of AI software algorithms, which may be used to perform supervised learning, unsupervised learning, reinforcement learning, deep learning, or any combination thereof. A variety of different machine learning algorithms may be employed in implementations. Examples of machine learning algorithms may include, inter alia, artificial neural network algorithms, Gaussian process regression algorithms, fuzzy logic-based algorithms, or decision tree algorithms.

In some implementations, more than one machine learning algorithm may be employed. For example, automated classification may be implemented using one type of machine learning algorithm, and adaptive real-time process control may be implemented using a different type of machine learning algorithm. In some implementations, hybrid machine learning algorithms including features and properties drawn from two, three, four, five, or more different types of machine learning algorithms may be employed in implementations.

Supervised learning algorithms may use labeled training data to infer a relationship between one or more identifiable aspects of a given entity and a classification of the entity according to a specified set of criteria or to infer a relationship between input process control parameters and desired outcomes. The training data may include paired training examples. For example, each training data example may include aspects identified for a given entity and the resultant classification of the given entity. As a further example, each training data example may include process control parameters used in a process and a known outcome of the process.

Unsupervised learning algorithms may be used to draw inferences from training data including entity data not paired with labeled entity classification data, or input process control parameter data not paired with labeled process outcomes. An example unsupervised learning algorithm is cluster analysis, which may be used for exploratory data analysis to find hidden patterns or groupings in process data. Further, implementations may employ unsupervised learning for anomaly detection in code changes without the need for labeled data.

Semi-supervised learning algorithms may use both labeled and unlabeled object classification or process data for training. Semi-supervised learning algorithms may typically use a small amount of labeled data with a large amount of unlabeled data.

Reinforcement learning algorithms may be used, for example, to optimize a process (e.g., steps or actions of the process) to maximize a process reward function or minimize a process loss function. In machine learning environments, reinforcement learning algorithms may be formulated as Markov decision processes. Reward functions or loss functions, which may also be referred to as cost functions or error functions, may map values of one or more process variables and/or outcomes to a real number that represents a reward or cost, respectively, associated with a given process outcome or event. Examples of process parameters and process outcomes include, inter alia, process throughput, process yield, production quality, or production cost. In some cases, the definition of the reward or loss function to be maximized or minimized, respectively, may depend on the choice of machine learning algorithm used to run the process control method, or vice versa. For example, if an objective is to maximize a total reward/value function, a reinforcement learning algorithm may be chosen. If the objective is to minimize a mean squared error loss function, a decision tree regression algorithm or linear regression algorithm may be chosen. In general, the machine learning algorithm used to run the process control method will seek to optimize the reward function or minimize the loss function by identifying the current state of the process; comparing the current state to the reference state, which may be a target intermediate or final state; and adjusting one or more process control parameters to minimize a difference between the two states. This adjustment may include reference to past learning provided by a training data set. Reinforcement learning algorithms differ from supervised learning algorithms in that correct training data input/output pairs are not presented, nor are sub-optimal actions explicitly corrected. Implementations of these algorithms tend to focus on real-time performance by finding a balance between exploration of possible outcomes based on updated input data and exploitation of past training.

Deep learning, which may also be known as deep structured learning, hierarchical learning, or deep machine learning, may be based on a set of algorithms that attempt to model high level abstractions in data. Deep learning algorithms may be inspired by the structure and function of the human brain and are part of a broader family of machine learning methods based on learning representations of data. Rooted in neural network technology, deep learning may involve a probabilistic graph model having many neuron layers, commonly known as a deep architecture. Deep learning technology may process information such as, inter alia, image, text, or sound information in a hierarchical manner. An observation (e.g., a feature to be extracted for reference) can be represented in many ways including, for example, a vector of intensity values, a set of edges, regions of shape, or in another abstract manner. Some representations may simplify the learning task (e.g., face recognition or facial expression recognition). Deep learning can provide efficient algorithms for unsupervised or semi-supervised feature learning and hierarchical feature extraction. Implementations employing deep learning can further benefit from the advantage of deep learning concepts in solving a normally intractable representation inversion problem.

A deep learning module may be configured as a neural network. The deep learning module may further be a deep neural network with a set of weights that model the world based on training using training data. Neural networks can be understood to implement a computational approach—based on a relatively large collection of neural units—to loosely model the way a human brain solves problems with large clusters of biological neurons connected by axons. Each neural unit may be connected to one or more others, and links can be enforcing or inhibitory in their effect on the activation state of connected neural units. These systems may be self-learning and trained rather than explicitly programmed. Neural network systems excel in areas where a solution or feature detection is difficult to express in a traditional computer program.

An example of a deep learning algorithm may be an artificial neural network (ANN). Large ANNs including many layers may be used, for example, to map entity data to entity classification decisions or to map input process control parameters to desired process outcomes. ANNs will be discussed in further detail below.

Neural networks typically include multiple layers, and the signal path may traverse from front to back. The goal of neural networks may be to solve problems in a similar manner to the human brain, although several neural networks may be much more abstract. In a simple example of a neural network, there may be two layers (i.e., sets) of neurons: an input layer that receives an input signal and an output layer that sends an output signal. When the input layer receives an input, it may pass a modified version of the input to the next layer. In a deep network, there may be many layers between the input layer and output layer, allowing the algorithm to use multiple processing layers, which may include multiple linear and non-linear transformations. Modern neural networks typically work with a few thousand to a few million neural units and millions of connections. Neural networks may have various suitable architectures and/or configurations known in the art.

There are many variants of neural networks with deep architecture depending on the probability specification and network architecture, including, inter alia, deep belief networks (DBN), restricted Boltzmann machines (RBM), random forests, and autoencoders. Implementations of neural networks may vary depending on the size of input data, the number of features to be analyzed, and the nature of the problem. Other layers may be included in the deep learning module besides the neural networks disclosed herein.

Another type of deep neural network may be a convolutional neural network (CNN), which can be used for analysis of an entity or process. CNNs are commonly composed of layers of different types: convolution, pooling, upscaling, and fully connected layers. In some cases, an activation function such as a rectified linear unit (ReLU) function may be used in some of the layers. In a CNN architecture, there can be one or more layers for each type of operation performed. A CNN architecture may include any number of layers in total, and any number of layers for the different types of operations performed. The simplest CNN architecture starts with an input layer followed by a sequence of convolutional layers and pooling layers (e.g., layers otherwise configured for reducing the dimensionality of the feature map generated by the one or more convolutional layers while retaining the most important features, for example, max pooling layers) and ends with fully connected layers (e.g., a layer in which each of the nodes is connected to each of the nodes in the previous layer). Each convolution layer may include a plurality of parameters used for performing the convolution operations. Each convolution layer may also include one or more filters, which in turn may include one or more weighting factors or other adjustable parameters. In some instances, the parameters may include biases (e.g., parameters that permit an activation function to be shifted). In some cases, the convolutional layers may be followed by an ReLU activation function layer. Other activation functions can also be used, for example, inter alia, saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid functions. The convolutional, pooling and ReLU layers may function as learnable feature extractors, while the fully connected layers may function as machine learning classifiers. As with other artificial neural networks, the convolutional layers and fully connected layers of CNN architectures may include various computational parameters, for example, weights, bias values, and threshold values, which may be trained in a training phase.

Another type of deep neural network may be a visual geometry group (VGG) network. For example, VGG networks may be created by increasing the number of convolutional layers while fixing other parameters of the architecture. Adding convolutional layers to increase depth may be made possible by using substantially small convolutional filters in all of the layers. VGG networks may also include convolutional layers followed by fully connected layers.

Another type of deep neural network may be a deep residual network. Like some other networks described herein, a deep residual network may include convolutional layers followed by fully connected layers, which may be, in combination, configured and trained for feature property extraction. A deep residual network's layers may be configured to learn residual functions with reference to layer inputs, instead of learning unreferenced functions. Instead of relying on a direct fit of few stacked layers to a desired underlying mapping, a deep residual network's layers may be explicitly allowed to fit a residual mapping, which may be realized by feedforward neural networks having shortcut connections (i.e., connections that skip one or more layers). A deep residual network may be created by inserting shortcut connections into a plain neural network structure including convolutional layers, thereby modifying the plain neural network into a residual learning network.

In some implementations, the machine learning module may include a support vector machine (SVM), an artificial neural network (ANN), a decision tree-based expert learning system, an autoencoder, a clustering machine learning algorithm, or a nearest neighbor (e.g., kNN) machine learning algorithm, or combinations thereof, some of which will be described in further detail below.

Support vector machines (SVMs) may be supervised learning algorithms used for classification and regression analysis of entity classification data or process control. Given a set of training data examples (e.g., entity or process data), each marked as belonging to a category, an SVM training algorithm may build a model that assigns new examples (e.g., data from a new entity or process) to a given category.

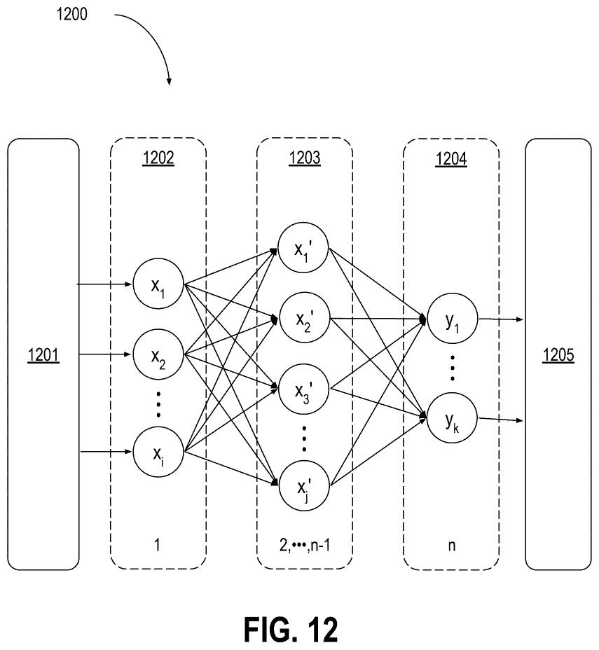

FIG. 12 illustrates an artificial neural network (ANN) 1200, according to one or more implementations herein. ANN 1200 may be used for, inter alia, classification or process control optimization according to various implementations.

ANN 1200 may include any type of neural network module, such as, inter alia, a feedforward neural network, radial basis function network, recurrent neural network, or convolutional neural network.

In implementations implementing ANN 1200 for entity classification, ANN 1200 may be employed to map entity data to entity classification data. In implementations implementing ANN 1200 for process optimization, ANN 1200 may be employed to determine an optimal set or sequence of process control parameter settings for adaptive control of a process in real-time based on a stream of process monitoring data and/or entity classification data provided by, for example, observation or from one or more sensors. ANN 1200 may include an untrained ANN, a trained ANN, pre-trained ANN, a continuously updated ANN (e.g., an ANN utilizing training data that is continuously updated with real time classification data or process control and monitoring data from a single local system, from a plurality of local systems, or from a plurality of geographically distributed systems).

ANN 1200 may include interconnected nodes (e.g., x₁-xᵢ, x₁′-xⱼ′, and y₁-yₖ) organized into n layers of nodes, where x1-xi represents a group of i nodes in an input layer 1202 (e.g., layer 1), x₁′-xⱼ′ represents a group of j nodes in one or more hidden layers 1203 (e.g., layer(s) 2 through n−1), and y₁-yₖ represents a group of k nodes in a final layer 1204 (e.g., layer n). Input layer 1202 may be configured to receive input data 1201 (e.g., sensor data, image data, sound data, observed data, automatically retrieved data, manually input data, etc.). Final layer 1204 may be configured to provide result data 1205.

There may be one or more hidden layers 1203, and the number j of nodes in the one or more hidden layers 1203 may vary from implementation to implementation. Thus, ANN 1200 may include any total number of layers (e.g., the one or more hidden layers 1203). One or more of the hidden layers 1203 may function as trainable feature extractors, which may allow mapping of input data 1201 to preferred result data 1205.

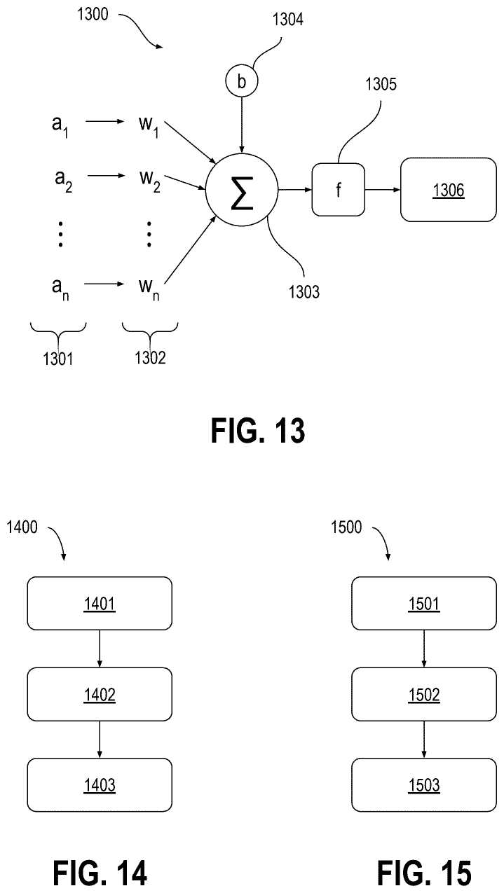

FIG. 13 illustrates a node 1300, according to one or more implementations herein. Each layer of a neural network may include one or more nodes similar to node 1300, for example, nodes x₁-xᵢ, x₁′-xⱼ′, and y₁-yₖ depicted in FIG. 13. Each node may be analogous to a biological neuron.

Node 1300 may receive node inputs 1301 (e.g., a₁-aₙ) either directly from the ANN's input data (e.g., input data 1201) or from the output of one or more nodes in a different layer or the same layer. With node inputs 1301, the node 1300 may perform an operation 1303, which while depicted in FIG. 13 as a summation operation, would be readily understood to include various other operations known in the art.

In some cases, node inputs 1301 may be associated with one or more weights 1302 (e.g., w₁-wₙ), which may represent weighting factors. For example, operation 1303 may sum the products of each of node inputs 1301 and associated weights 1302 (e.g., aᵢwᵢ).

The result of operation 1303 may be offset with one or more biases 1304 (e.g., bias b), which may be a value or a function.

Output 1306 of node 1300 may be gated using an activation (or threshold) function 1305 (e.g., function f), which may be a linear or a nonlinear function. Activation function 1305 may be, for example, a ReLU activation function or other function such as a saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid function, or any combination thereof.

Weights 1302, biases 1304, or threshold values of activation function 1305, or other computational parameters of the neural network, can be “taught” or “learned” in a training phase using one or more sets of training data. For example, the parameters may be trained using input data from a training data set and a gradient descent or backward propagation method so that the output value(s) (e.g., a set of predicted adjustments to classification or process control parameter settings) computed by the ANN may be consistent with the examples included in the training data set. The parameters may be obtained, for example, from a back propagation neural network training process, which may or may not be performed using the same hardware as that used for automated classification or adaptive, real-time deposition process control.

Decision tree-based expert systems may be supervised learning algorithms designed to solve entity classification problems or process control problems by applying a series of conditional (e.g., if-then) rules. Expert systems may include two subsystems: an inference engine and a knowledge base. The knowledge base may include a set of facts (e.g., a training data set including entity data for a series of entities, and the associated entity classification data provided by, for example, a skilled operator, technician, or inspector) and derived rules (e.g., derived entity classification rules). The inference engine may then apply the rules to input data for a current entity classification problem or process control problem to determine a classification of the entity or a next set of process control adjustments.

Autoencoders (also sometimes referred to as an auto-associator or Diabolo network), may be an ANN used for unsupervised and efficient mapping of input data (e.g., entity data or process data), to an output value (e.g., an entity classification or optimized process control parameters). Autoencoders may be used for the purpose of dimensionality reduction, that is, a process of reducing the number of random variables under consideration by deducing a set of principal component variables. Dimensionality reduction may be performed, for example, for the purpose of feature selection (e.g., selecting a subset of the original variables) or feature extraction (e.g., transforming of data in a high-dimensional space to a space of fewer dimensions).

FIG. 14 illustrates a method 1400 of training a machine learning model of a machine learning module, according to one or more implementations herein. Use of method 1400 may provide for use of training data to train a machine learning model for concurrent or later use.

At 1401, a machine learning model including one or more machine learning algorithms may be provided.

At 1402, training data may be provided. Training data may include one or more of process simulation data, process characterization data, in-process or post-process inspection data (including inspection data provided by a skilled operator and/or inspection data provided by any of a variety of automated inspection tools), or any combination thereof, for past processes that are the same as or different from that of the current process. One or more sets of training data may be used to train the machine learning algorithm used for object defect detection and classification. In some cases, the type of data included in the training data set may vary depending on the specific type of machine learning algorithm employed.

At 1403, the machine learning model may be trained using the training data. For example, training the model may include inputting the training data to the machine learning model and modifying one or more parameters of the model until the output of the model is the same as (or substantially the same as) external validation data. Model training may generate one or more trained models. One or more trained models may be selected for further validation or deployment, which may be performed using validation data. The results produced by each trained model for the validation data input to the training model may be compared to the validation data to determine which of the models is the best model. For example, the trained model that produces results most closely matching the validation data may be selected as the best model. Test data may then be used to evaluate the selected model. The selected model may also be sent to model deployment in which the best model may be sent to the processor for use in a post-training mode.

FIG. 15 illustrates a method 1500 of analyzing input data using a machine learning module, according to one or more implementations herein. Use of the machine learning module described by method 1500 may enable, for example, automatic classification of an entity or optimized process control.

At 1501, a trained machine learning model may be provided to the machine learning module. The trained machine learning model may have been trained, or under continuous or periodic training by one or more other systems or methods. The machine learning model may be pre-generated and trained, enabling functionality of the module as described herein, which can then be used to perform one or more post-training functions of the machine learning module.

For example, the provided trained machine learning model may be similar to ANN 1200, include nodes similar to node 1300, and may have been trained (or be under continuous or periodic training) using a method similar to method 1400.

At 1502, input data may be provided to the machine learning module for input into the machine learning model. The input data may result from or be derived from a variety of different sources, similar to input data 1201.

The provision of input data at 1502 may further include removing noise from the data prior to providing it to the machine learning algorithm. Examples of data processing algorithms suitable for use in removing noise from the input data may include, inter alia, signal averaging algorithms, smoothing filter algorithms, Kalman filter algorithms, nonlinear filter algorithms, total variation minimization algorithms, or any combination thereof.

The provision of input data at 1502 may further include subtraction of a reference data set from the input data to increase contrast between aspects of interest of an entity or process and those not of interest, thereby facilitating classification or process control optimization. For example, a reference data set may include input data for a real or contrived ideal example of the entity or process. If an image sensor or machine vision system is used for entity observation, the reference data set may include an image or set of images (e.g., representing different views) of an ideal entity.

At 1503, the machine learning module may process the input data using the trained machine learning model to yield results from the machine learning module. Such results may include, for example, an entity classification or one or more optimized process control parameters.

Use cases of implementations herein may include, for example: large-scale enterprise software projects, where the execution of all tests in extensive test suites becomes impractical requiring prioritization; CI/CD, where rapid development cycles benefit from early feedback; resource-constrained projects, where limited resources may be focused on prioritized test cases; and quality-focused teams, where identifying likely failure points in code before testing provides for proactive bug-fixing and continuous improvement.

Implementations may offer several advantages over traditional software testing approaches. Efficiency may be improved by reducing the time and computational resources required for software testing by predicting test outcomes and prioritizing high-risk test cases. Early defect detection may be provided by predicting likely test failures before code is executed; the system enables developers to detect and address potential issues earlier in the development cycle. Developer productivity may be improved by the provision of actionable insights to help developers focus efforts on prioritized test cases and code segments/features. Implementations may be adaptable, continuously learning and adapting to changes in the codebase and the development environment, thereby improving its predictions over time. Software or product quality may be enhanced by identifying likely defects before they impact end users or delay releases. Security may be improved by the prediction of potential security vulnerabilities in code, using machine learning techniques to identify common security flaws and risks.

The invention is limited only by the appended claims. Variations, characteristics, advantages, implementations, constructions, arrangements, terminology, materials, dimensions, embodiments, illustrations, depictions, and examples composing the above description and accompanying drawings show some possible implementations of the invention without limiting the invention. It is not necessary that every implementation of the invention achieve or possess every advantage, purpose, or characteristic identified herein, and as such, one skilled in the art may effect various additions, changes, modifications, or omissions without departing from the scope or spirit of the invention or its legal equivalents.

All ranges are inclusive of the stated limits, the orders of magnitude thereof, and all values and ranges substantially therebetween unless otherwise defined. Unless otherwise stated, every use of “and” forms an inclusive list comprising at least the conjoined elements, and every use of “or” forms an inclusive list comprising at least one element of conjoined elements. Unless otherwise stated, singular usage (e.g., ‘a’, ‘an’, or ‘the’) includes plurals of the same.

The order of recitations in a claim do not imply a temporal or ordered relationship unless unavoidable by the plain language of that claim. No claim may be interpreted to invoke 35 U.S.C. § 112(f) unless that claim recites “means for” or “step for.”

What is claimed is:

1. A method for predicting a passage likelihood of a software code as applied to a test case, comprising, by a processor:
receiving the software code at the processor;
extracting a feature from the software code;
retrieving from a database stored on a memory in electronic communication with the processor a test case corresponding to the feature;
mapping the test case to the feature; and
predicting, by a hybrid prediction model comprising a trained machine learning model and a large language model, whether the feature is likely to pass or fail the test case, thereby yielding a test outcome including the passage likelihood.

2. The method of claim 1, wherein the hybrid prediction model includes an ensemble integration layer configured to integrate an output of the trained machine learning model with an output of the large language model.

3. The method of claim 1, further comprising determining using the hybrid prediction model a confidence score of the passage likelihood.

4. The method of claim 1, further comprising transmitting, via a network interface in electronic communication with the processor, the test outcome to an external device.

5. The method of claim 1, further comprising:
receiving, via a network interface in electronic communication with the processor, user feedback corresponding to the test outcome; and
training the hybrid prediction model using the user feedback.

6. The method of claim 1, further comprising training the hybrid prediction model using the test outcome.

7. The method of claim 1, wherein the extracting the feature from the software code includes determining a segment of the software code that has been changed from a prior version of the software code, thereby yielding the feature.

8. The method of claim 1, further comprising assigning a test execution priority to the test case based on the passage likelihood.

9. The method of claim 1, further comprising identifying, by the hybrid prediction model, a developer behavior pattern based on the software code.

10. The method of claim 1, further comprising suggesting, by the hybrid prediction model, a further test case.

11. The method of claim 1, further comprising generating, by the large language model, a natural language explanation of the test outcome.

12. A system for predicting a passage likelihood of a software code as applied to a test case, comprising:
a processor of an application server; and
a memory in electronic communication with the processor, the memory having a database stored thereon;
wherein the processor is configured to:
receive the software code;
extract a feature from the software code;
retrieve from the database a test case corresponding to the feature;
map the test case to the feature; and
predict, by a hybrid prediction model comprising a trained machine learning model and a large language model, whether the feature is likely to pass or fail the test case, thereby yielding a test outcome including the passage likelihood.

13. The system of claim 12, wherein the hybrid prediction model includes an ensemble integration layer configured to integrate an output of the trained machine learning model with an output of the large language model.

14. The system of claim 12, further comprising a network interface in electronic communication with the processor, wherein the processor is configured to transmit, via the network interface, the test outcome to an external device.

15. The system of claim 12, wherein the memory includes stored thereon a frequently-accessed feature vector.

16. The system of claim 12, wherein the database comprises a time-series database optimized for fast querying of temporal data.

17. The system of claim 12, wherein the database comprises a distributed database.

18. The system of claim 12, wherein the extracting the feature from the software code includes determining a segment of the software code that has been changed from a prior version of the software code, thereby yielding the feature.

19. The system of claim 12, wherein the processor is further configured to generate, by the large language model, a natural language explanation of the test outcome.

20. A tangible, non-transitory, computer-readable media having instructions thereupon which when implemented by a processor cause the processor to perform a method for predicting a passage likelihood of a software code as applied to a test case, comprising:
receiving the software code at the processor;
extracting a feature from the software code;
retrieving from a database stored on a memory in electronic communication with the processor a test case corresponding to the feature;
mapping the test case to the feature; and
predicting, by a hybrid prediction model comprising a trained machine learning model and a large language model, whether the feature is likely to pass or fail the test case, thereby yielding a test outcome including the passage likelihood.
